(19) United States
(12) Patent Application Publication
(10) Pub. No.: US 2011/0199558 A1
(43) Pub. Date: Aug. 18, 2011

(54) BACKLIGHT UNIT AND LIQUID CRYSTAL DISPLAY DEVICE

(75) Inventor: Tetsuya Hamada, Osaka-shi (JP)

(73) Assignee: SHARP KABUSHIKI KAISHA, Osaka-shi, Osaka (JP)

(21) Appl. No.: 13/124,398

(22) PCT Filed: Sep. 4, 2009
(86) PCT No.: PCT/JP2009/065483

§ 371 Date: Apr. 15, 2011

(30) Foreign Application Priority Data
Jan. 22, 2009 (JP) 2009-012210

(51) Int. Cl. G02F 1/13357; F21V 7/22

(52) U.S. Cl. 349/62; 362/611; 362/613

(57) ABSTRACT

A backlight unit (49) wherein a light-receiving surface (RS) is formed on a lateral surface (21S) of a light guide plate (2) so as to face a light-emitting surface (11L) of an LED (11). The light-receiving surface (RS) is positioned in a corner (21C) of the light guide plate (21), and at least two corners (21C) next to each other in the light guide plate (21) have the light-receiving surface (RS).

### TECHNICAL FIELD

The present invention relates to a backlight unit (illumination apparatus) that emits light and a liquid crystal display device that uses the light from the backlight unit.

### BACKGROUND ART

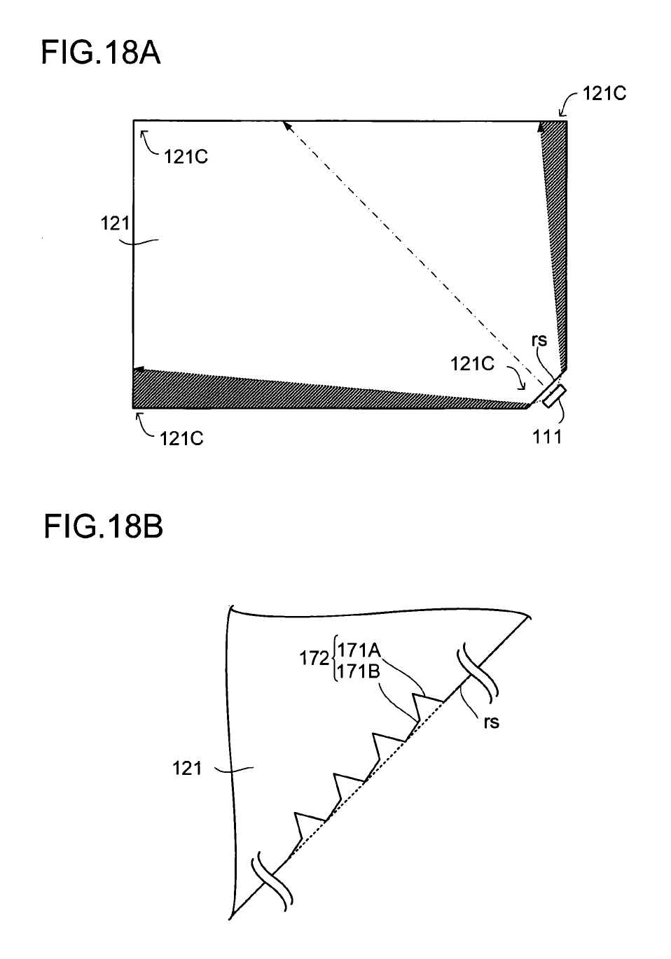

Recently, in a backlight unit that is incorporated in a liquid crystal display device, to achieve cost reduction, reduction in the number of LEDs that are light emitting devices is achieved. For example, as shown in a plan view of FIG. 18A, one LED 111 is disposed at one corner 121C of a light guide plate 121. Accordingly, light emitted from the LED 111 efficiently reaches the entire light guide plate 121, so that even the only one LED 111 is able to make the inside of the light guide plate 121 bright in a relatively wide area.

However, with the only one LED 111, the light does not sufficiently reach the entire light guide plate 121, so that a region (dark region; see slanted lines in the figure) where the light does not reach occurs. Because of this, in a backlight unit described in a patent document 1, as shown in FIG. 18B, on a light receiving surfacers formed at the corner 121C of the light guide plate 121, a plurality of second cutouts 172 that include two kinds of first cutouts 171A, 171B are formed.

According to this, by one cutout 171A and the other cutout 171B of the second cutout 172, the light from the LED 111 is separated to travel in a long-edge direction and a short-edge direction of the light guide plate 121 in a well-balanced way, so that the light reaches sufficiently the entire light guide plate 121.

### Citation List

### Patent Literature

PLT1 : JP-A-2006-185852

### SUMMARY OF INVENTION

### Technical Problem

However, because the plurality of second cutouts 172 are relatively small, naturally the first cutouts 171A, 171B become smaller. Because of this, the first cutouts 171A, 171B and the second cutouts 172 are sometimes formed contrary to the design. In such a case, a dark region occurs in the light guide plate 121, so that light unevenness due to the dark region is included in the light from the backlight unit. Besides, the forming of the second cutouts 172 on the light guide plate 121, or a metal mold of the light guide plate 121 for forming the second cutouts 172 is expensive.

Besides, the light that enters the light guide plate 121 via the plurality of second cutouts 172 sometimes excessively spreads; in such a case, the light that reaches a side surface of the light guide plate 121 sometimes exits from the light guide plate 121 to outside. Because of this, use efficiency of the light deteriorates.

The present invention has been made to solve the above problems. And, it is an object of the present invention to provide easily and inexpensively a backlight unit and the like that reduce dark regions in a light guide plate; curb light unevenness due to the dark regions; and improve use efficiency of light.

### Solution to Problem

The backlight unit includes: a first light emitting device; and a light guide plate that receives light from the first light emitting device and transmits the light to guide the light from a top surface to outside. And, in this backlight unit, light receiving surfaces, which are formed on part of a side surface of the light guide plate and face a light emitting surface of the first light emitting device, are situated at corners of the light guide plate; and positions of the corners are positions of at least two corners that are adjacent to each other on the light guide plate.

Usually, the first light emitting device diffuses the light while emitting the light (forms light flux that has a predetermined directivity). Accordingly, the light from the first light emitting device, which enters the light guide plate from the corner via the light receiving surface, easily reaches a side surface of the light guide plate that is adjacent to the light receiving surface. In addition, even if a region (dark region), where only one of the plurality of light emitting devices is not able to make the light reach, occurs near the side surface of the light guide plate that is adjacent to the light receiving surface, the light from another first light emitting device reaches the dark region. Because of this, the dark region on the light guide plate reduces. As a result of this, in this backlight unit, light unevenness due to the dark region is unlikely to occur.

Here, to increase choices of the first light emitting device, it is desirable that one or a plurality of the first light emitting devices are disposed corresponding to one light receiving surface. According to this, for example, it is possible to make the first light emitting device having relatively high brightness face the one light receiving surface; or it is possible to make a plurality of the first light emitting devices, which do not have high brightness but are inexpensive, face the one light receiving surface.

Besides, it is desirable that on the one light receiving surface, a non-planar shape that changes a travel direction of received light is formed. For example, it is desirable that on the one light receiving surface, one concave that caves in a travel direction of the light from the first light emitting device is formed. And, an inner surface of the concave may be a polygonal surface that includes a plurality of arranged small surfaces or may be a curved surface.

According to this, in a case where part of the light from the first light emitting device travels into the inside of the light guide plate via the light receiving surface that has the concave, the traveling light advances without excessively going away from the side surface that is adjacent to the light receiving surface. Because of this, the dark region is unlikely to occur near the side surface of the light guide plate.

Here, besides the concave-shape light receiving surface, another non-planar shape light receiving surface is also conceivable. For example, on the one light receiving surface, a convex that swells toward the light emitting surface of the first light emitting device may be formed. In detail, a surface of the convex of the light receiving surface may be a polygonal surface that includes a plurality of arranged small surfaces, or may be a curved surface.

Besides, it is desirable that one light emitting surface of the first light emitting device is disposed to face each of the plurality of small surfaces included in the light receiving surface. According to this, the light traveling from a small surface adjacent to the side surface of the light guide plate easily reaches the side surface. Because of this, the dark region is further unlikely to occur near the side surface of the light guide plate.

Besides, it is desirable that near at least one of the side surfaces that are adjacent to each other with respect to the light receiving surface, a light emitting surface of a second light emitting device faces a place that is adjacent to the light receiving surface.

According to this, light from the second light emitting device enters from the side surface of the light guide plate where the dark region easily occurs. Because of this, in the backlight unit that incorporates the second light emitting device, light unevenness due to the dark region surely reduces.

In the meantime, it is desirable that the light emitting devices (that is, at least one of the first and second light emitting devices) are mounted on a mount board; the mount board on which the light emitting devices are mounted and the light guide plate are housed in a frame. Especially, it is desirable that on the frame, a hold portion that holds directly or indirectly the light emitting device is formed.

According to this, it is possible to easily make the mount board unmoved with respect to the frame. Further, in a case where the hold portion is so formed as to face the light receiving surface of the light guide plate; and the light receiving surface and one surface of the hold portion are parallel with each other, if on a non-mount surface, a portion which overlaps with the first light emitting device comes into contact with the one surface of the hold portion, the light receiving surface and the light emitting surface of the first light emitting device easily become parallel with each other. According to this, the light from the first light emitting device efficiently enters the light receiving surface.

Here, it is possible to say that a liquid crystal display device including the above backlight unit and a liquid crystal display panel that receives the light from the backlight unit is also the present invention.

Besides, in the liquid crystal display device, the mount board may also be a control board that is used for control of a liquid crystal display panel. According to this, an additional board for the light emitting device becomes unnecessary and it is possible to achieve cost reduction of the liquid crystal display device.

Besides, the liquid crystal display device may include: the mount board on which the light emitting device (that is, at least one of the first and second light emitting device) is mounted; the control board that is used for control of the liquid crystal display panel; and a board cover (e.g., a metal board cover) that has electrical conductivity and heat radiation which protects the control board; and on the board cover, a hold portion that holds directly or indirectly the light emitting device may be formed.

According to this, the board cover performs not only a function as a measure against EMI (Electromagnetic Interference) but also a function as a heat radiation path for heat stored in the light emitting device. Because of this, an additional heat radiation plate for the light emitting device becomes unnecessary.

### Advantageous Effects of Invention

In the backlight unit according to the present invention, with only a relatively small number of light emitting devices, it is possible to make the light reach most portions of the light guide plate; and the dark region in the inside (especially, near a side surface of the light guide plate) of the light guide plate reduces. Because of this, in this backlight unit, light unevenness due to the dark region reduces easily and inexpensively.

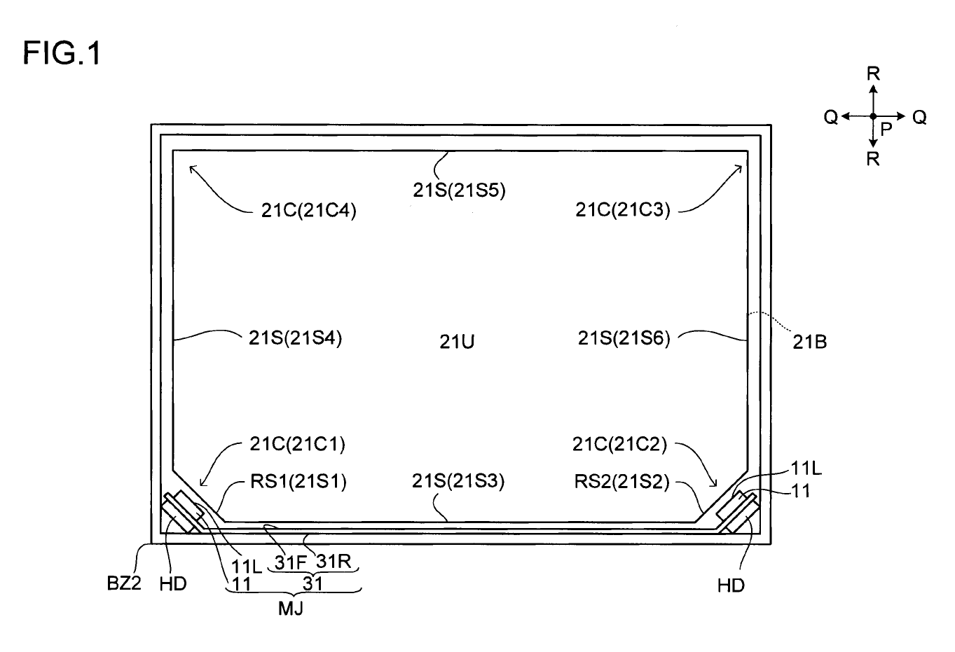

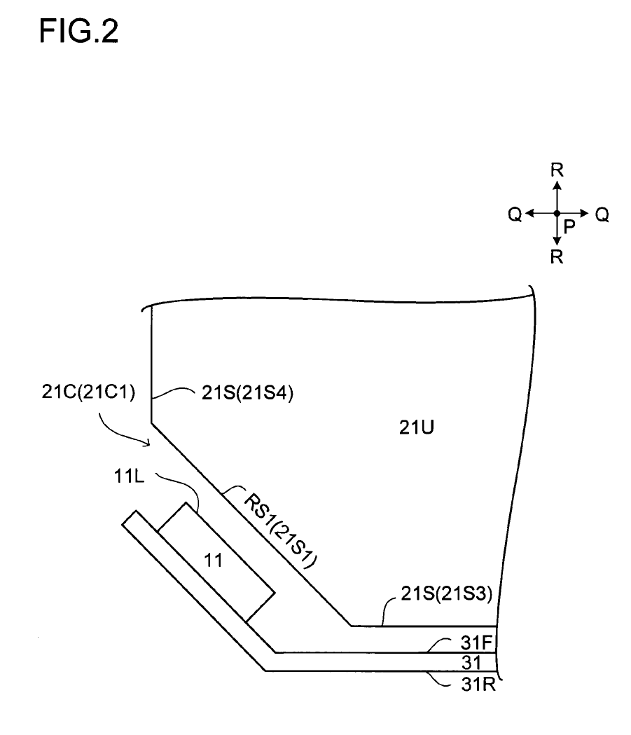

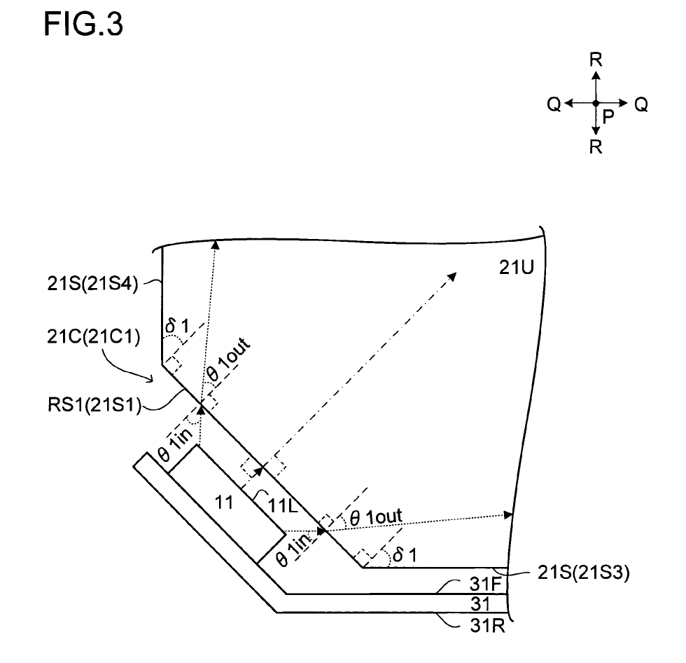

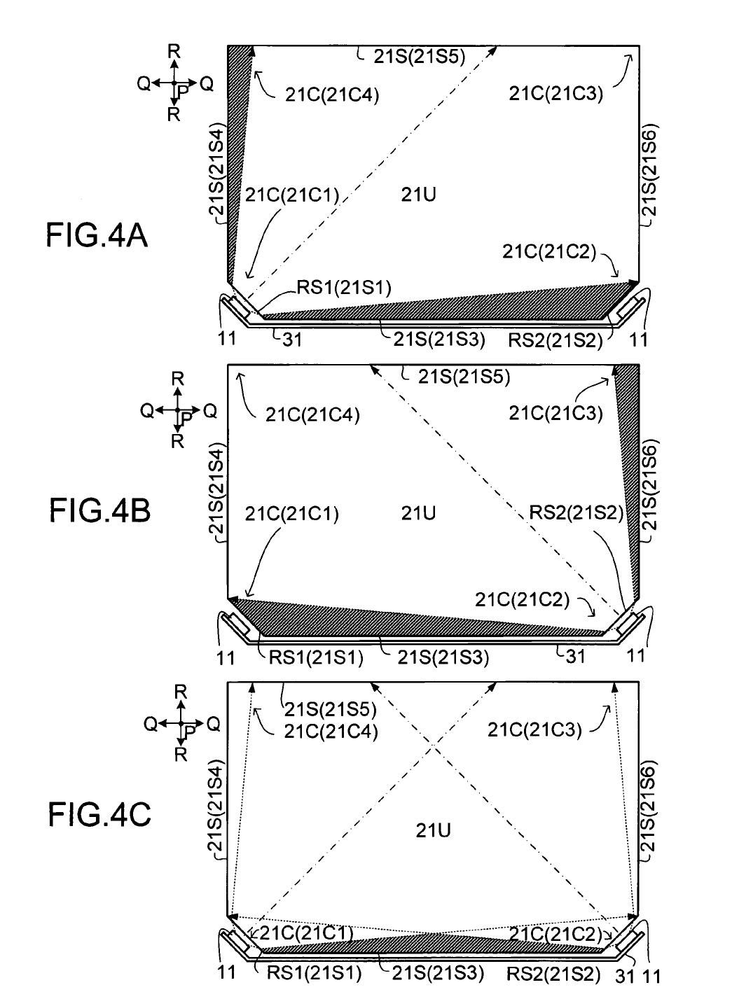

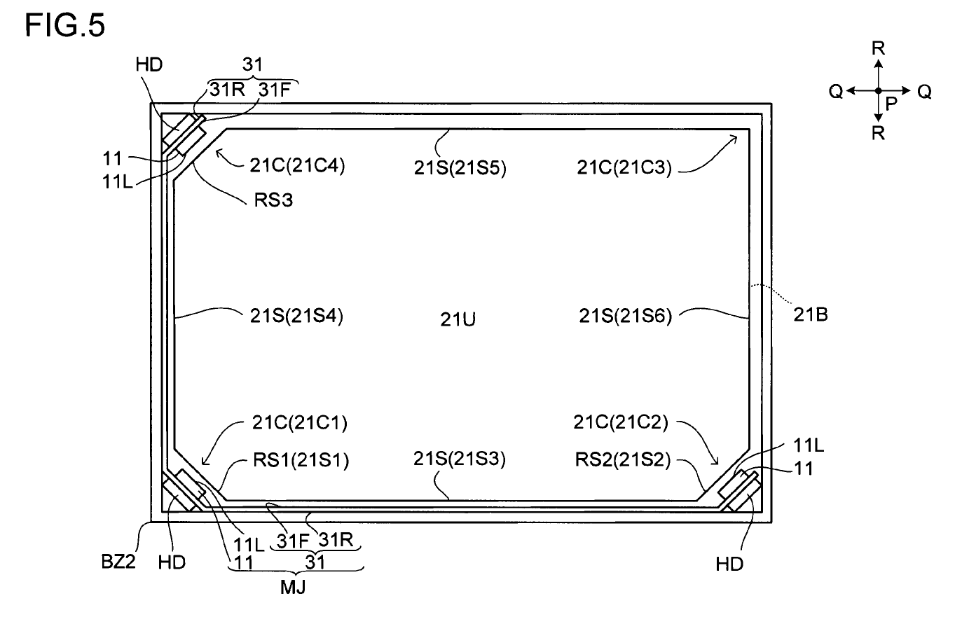

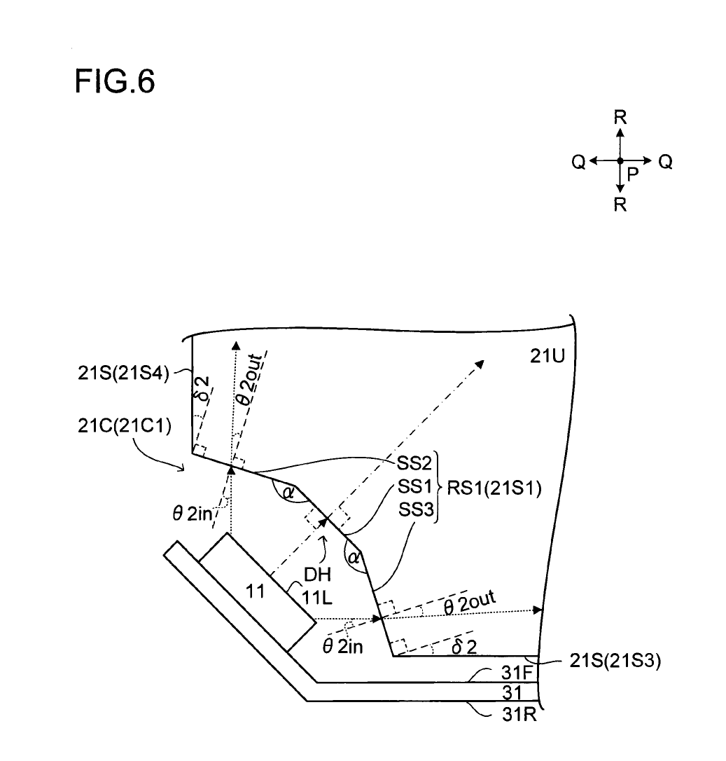

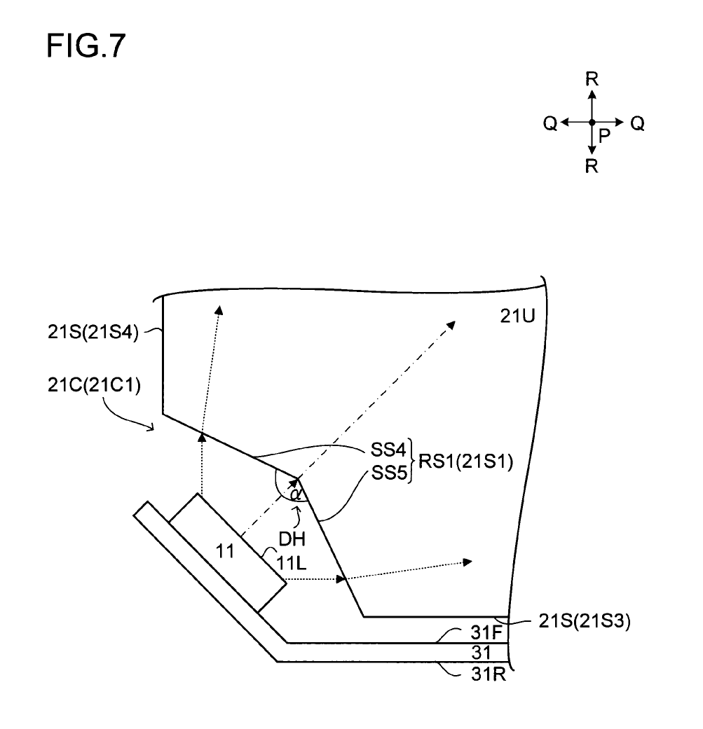

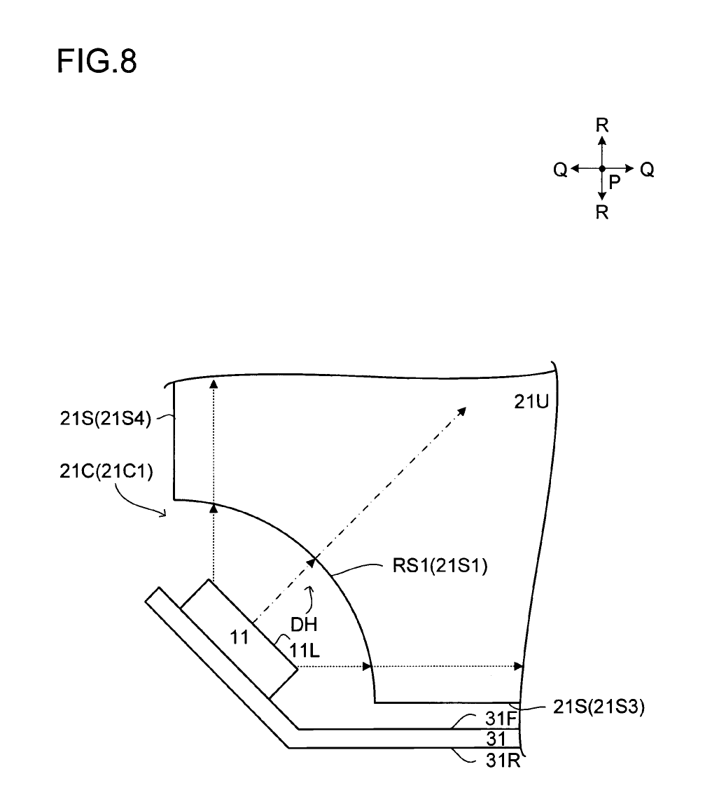

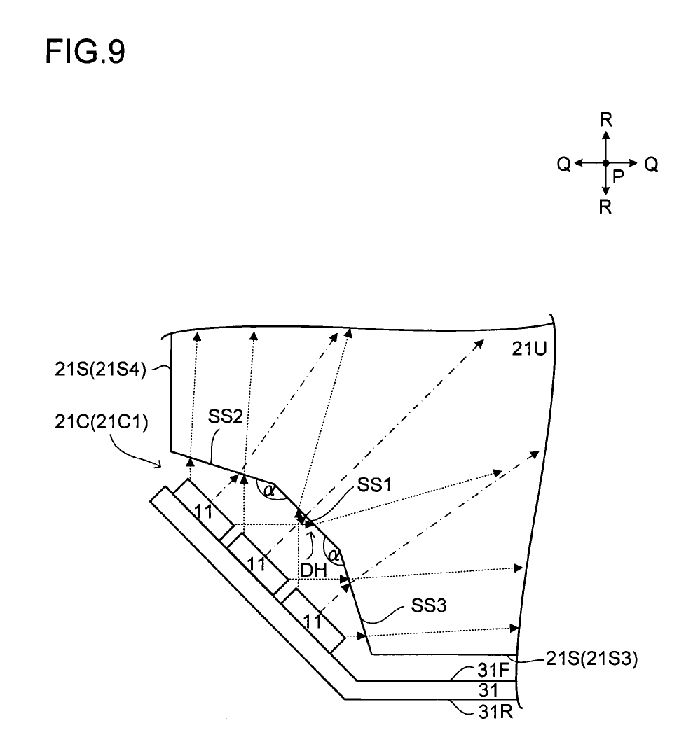

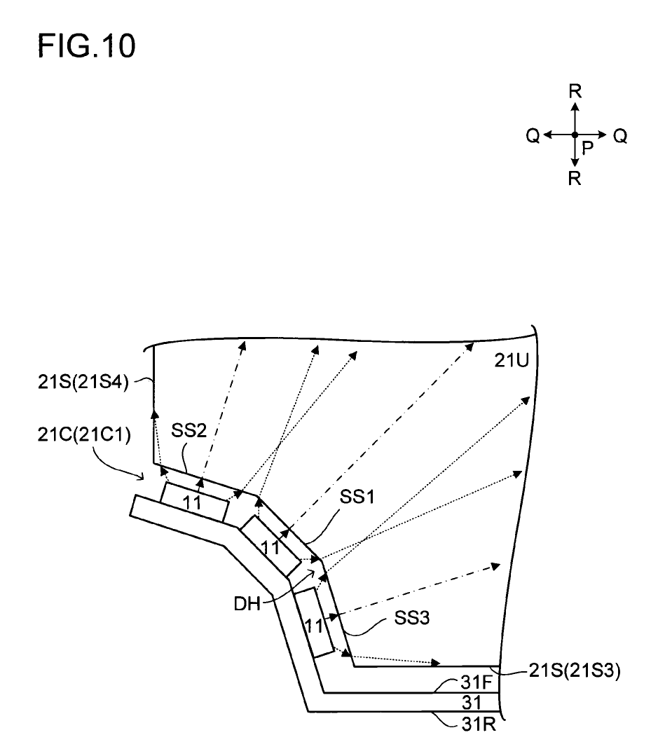

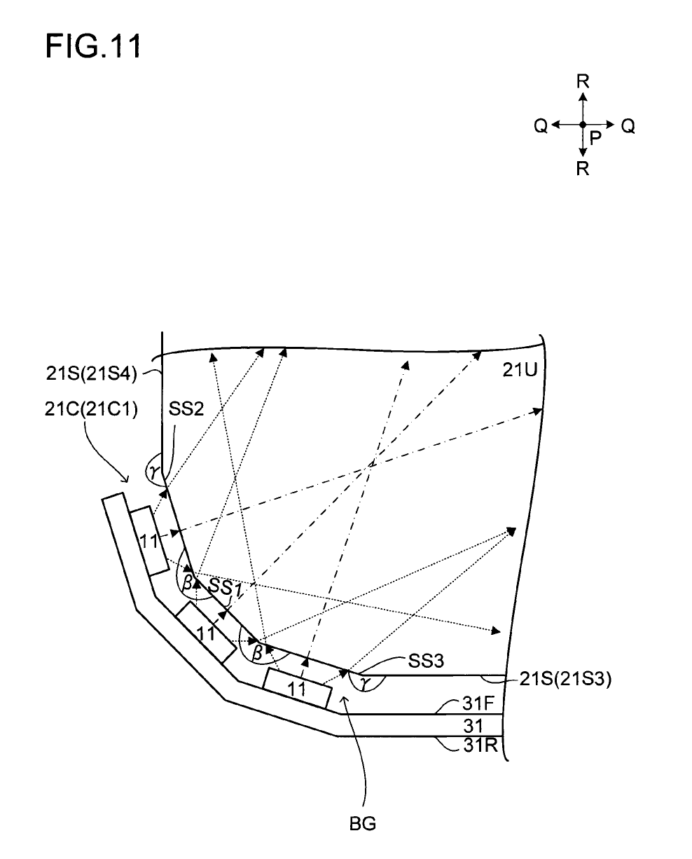

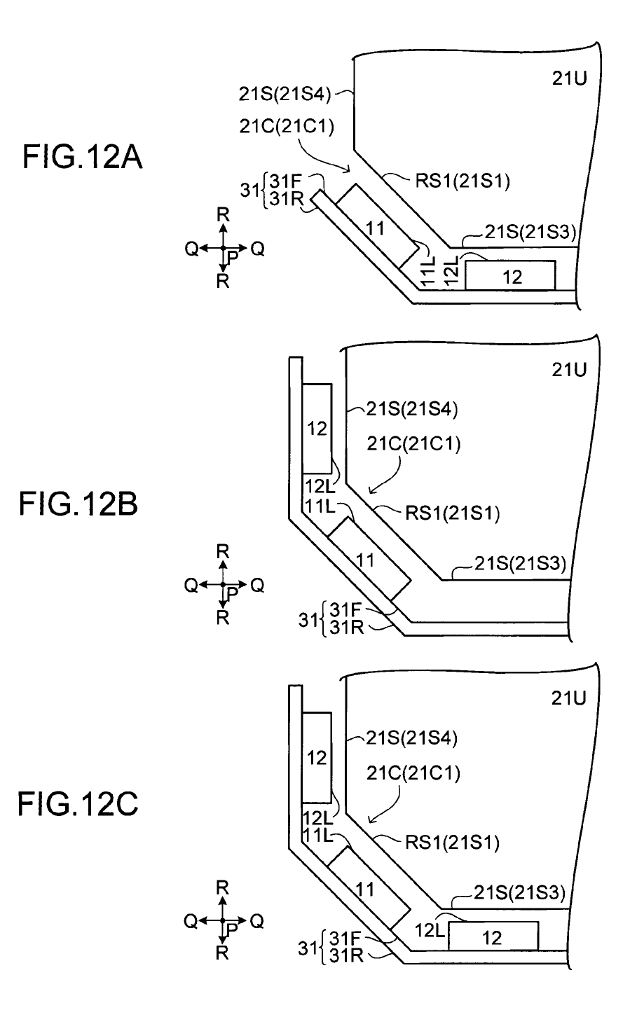

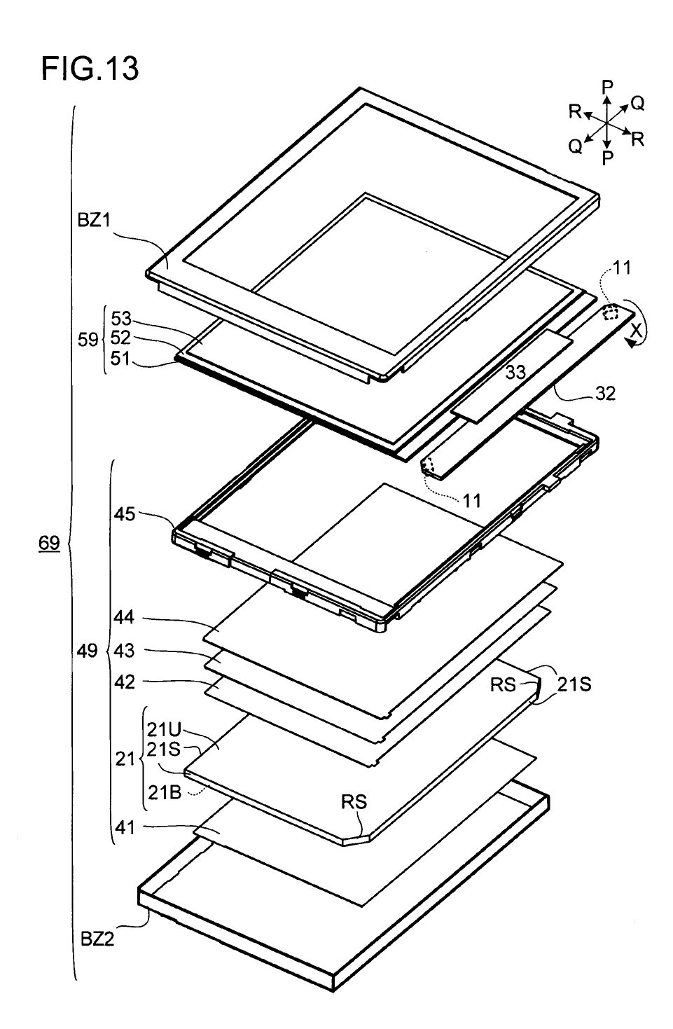

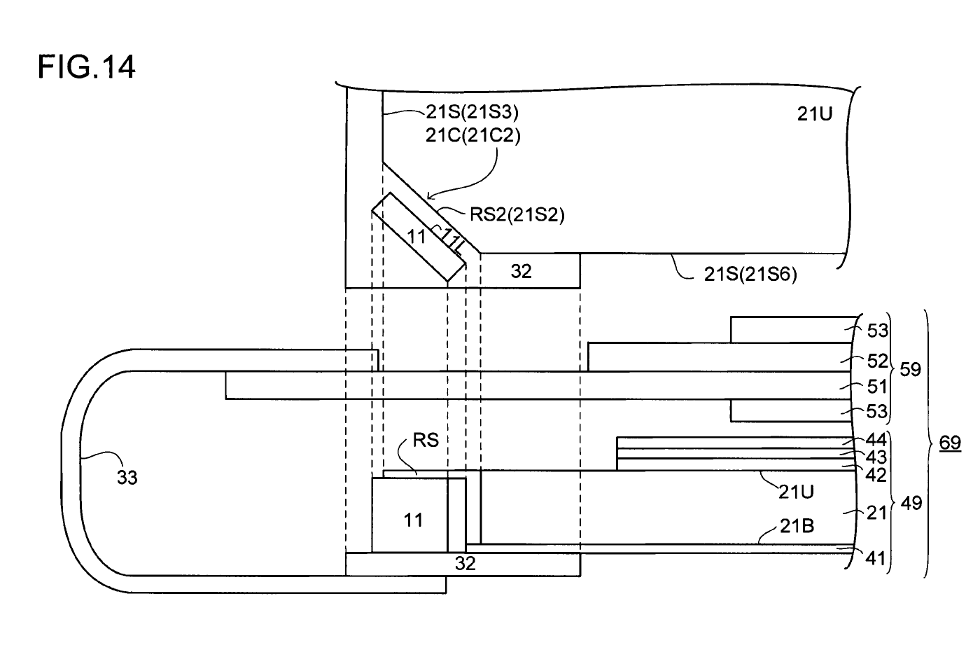

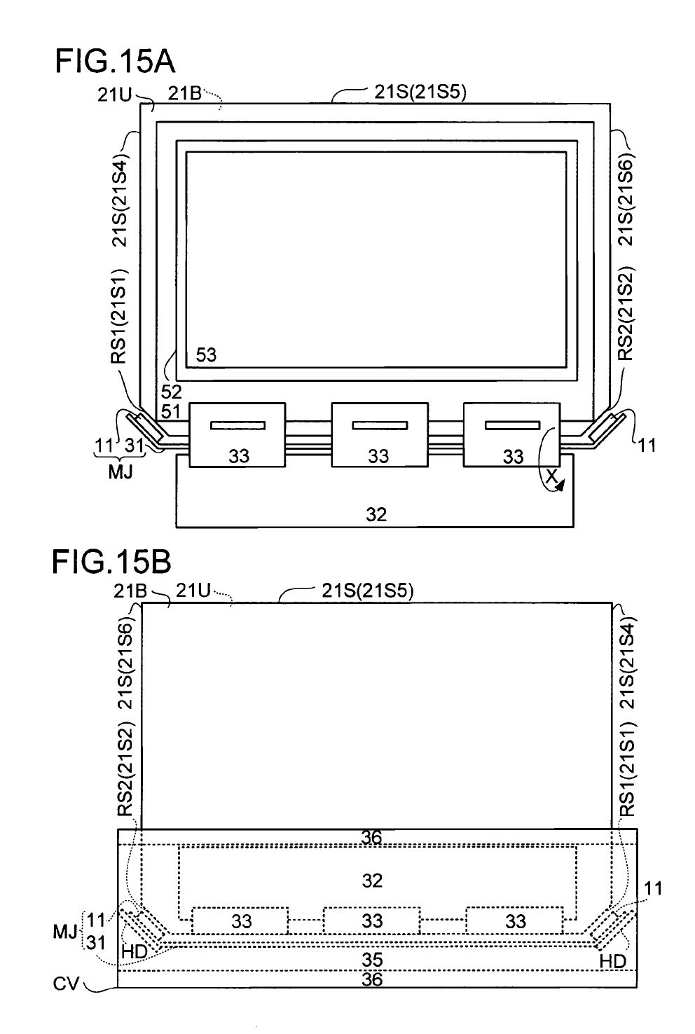

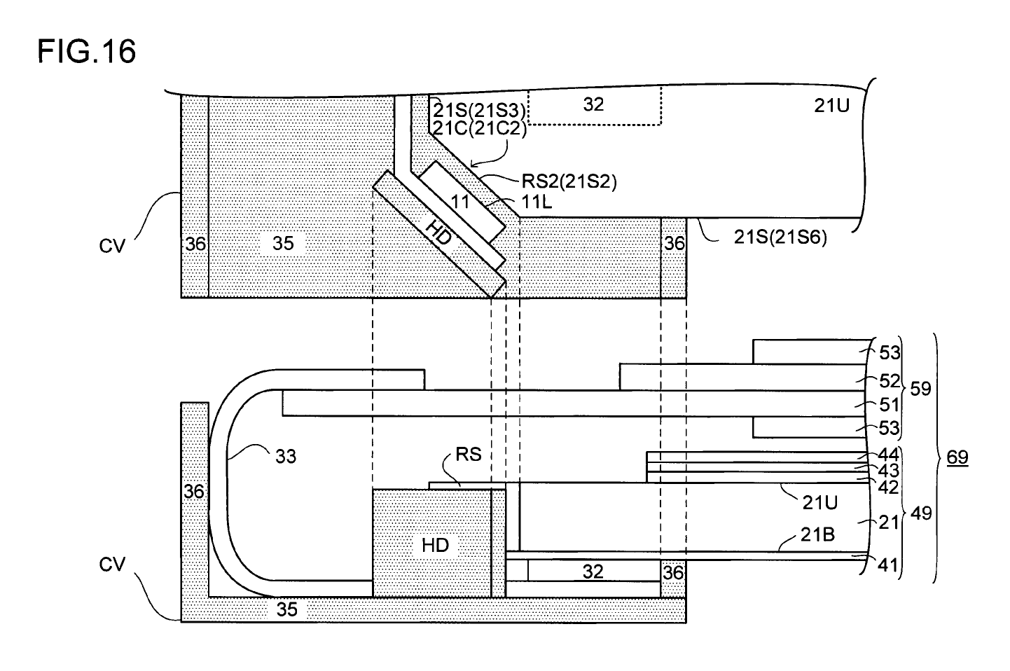

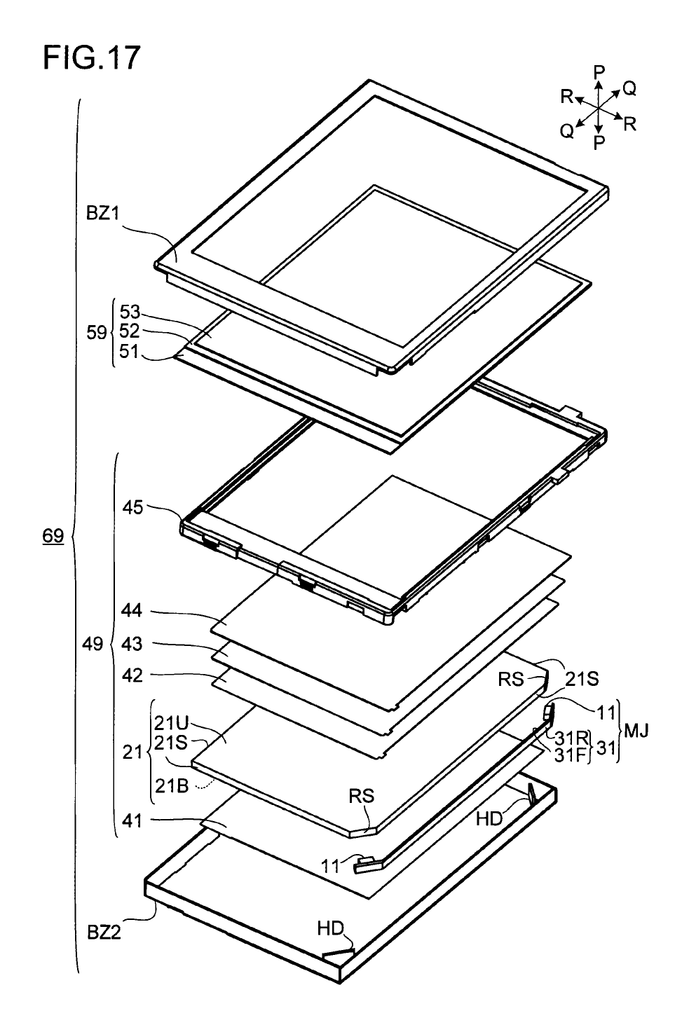

### BRIEF DESCRIPTION OF DRAWINGS

[FIG. 1] is a plan view showing a light guide plate and an LED module that are housed in a rear bezel.

[FIG. 2] is an enlarged plan view of one corner of a light guide plate and one LED.

[FIG. 3] is a plan view showing light from an LED as a light path.

[FIG. 4A] is a plan view showing a region of a light guide plate illuminated with light from one of two LEDs and a dark region other than the region.

[FIG. 4B] is a plan view showing a region of a light guide plate illuminated with light from the other of two LEDs and a dark region other than the region.

[FIG. 4C] is a plan view showing a region of a light guide plate illuminated with light from two LEDs and a dark region other than the region.

[FIG. 5] is a plan view showing a light guide plate and an LED that are housed in a rear bezel different from the rear bezel in FIG. 1.

[FIG. 6] is a plan view showing a concave-shape light receiving surface that includes three small surfaces formed at one corner of a light guide plate.

[FIG. 7] is a plan view showing a concave-shape light receiving surface that includes two small surfaces formed at one corner of a light guide plate.

[FIG. 8] is a plan view showing a concave-shape light receiving surface that includes one small surface formed at one corner of a light guide plate.

[FIG. 9] is a plan view showing a concave-shape light receiving surface that includes three small surfaces and three LEDs that face the light receiving surface.

[FIG. 10] is a plan view showing a concave-shape light receiving surface that includes three small surfaces and LEDs that face the respective small surfaces.

[FIG. 11] is a plan view showing a convex-shape light receiving surface that includes three small surfaces and LEDs that face the respective small surfaces.

[FIG. 12A] is a plan view showing an LED that faces a light receiving surface and an LED that faces a log-edge side surface of a light guide plate.

[FIG. 12B] is a plan view showing an LED that faces a light receiving surface and an LED that faces a short-edge side surface of a light guide plate.

[FIG. 12C] is a plan view showing an LED that faces a light receiving surface and LEDs that face long-edge and short-edge side surfaces of a light guide plate.

[FIG. 13] is an explosive perspective view of a liquid crystal display device.

[FIG. 14] is a two-directional view showing both of a partial side view and a partial plan view of a liquid crystal display device.

[FIG. 15A] is a plan view showing a portion of a liquid crystal display device.

[FIG. 15B] is a plan view showing a portion of a liquid crystal display device.

[FIG. 16] is a two-directional view showing both of a partial side view and a partial plan view of a liquid crystal display device.

[FIG. 17] is an explosive perspective view of a liquid crystal display device.

[FIG. 18A] is a plan view showing a light guide plate and an LED in a conventional backlight unit.

[FIG. 18B] is an enlarged plan view of a light receiving surface formed at a corner of a light guide plate.

### DESCRIPTION OF EMBODIMENTS

### Embodiment 1

An embodiment is described based on drawings as follows. Here, for convenience, members themselves, member numbers and the like are omitted in some cases; in these cases, other drawings are referred to. Besides, although it is not a sectional view, hatching is sometimes used. Besides, a black dot in a drawing means a direction perpendicular to a paper surface.

An exploded perspective view of FIG. 17 shows a liquid crystal display device 69. As shown in FIG. 17, the liquid crystal display device 69 includes: a liquid crystal display panel 59; a backlight unit 49; and bezels BZ (front bezel BZ1 and rear bezel BZ2) that sandwich and hold the liquid crystal display panel 59 and the backlight unit 49.

Here, the shape of the bezel (frame) BZ is not especially limited. For example, as shown in FIG. 17, the rear bezel BZ2 may be a box body that houses the liquid crystal display panel 59 and the backlight unit 49, while the front bezel BZ1 may be a frame body that covers the rear bezel BZ2 (here, because thee rear bezel BZ2 is a component that houses the backlight unit 49, the rear bezel BZ2 may be called a component of the backlight unit 49).

The liquid crystal display panel 59 attaches an active matrix board 51 that includes switching elements such as a TFT (Thin Film Transistor) and the like, and an opposite board 52 that faces the active matrix board 51 to each other by means of a seal member (not shown). And, liquid crystal (not shown) is injected into a gap between both boards 51, 52 (here, polarization films 53, 53 are so disposed as to sandwich the active matrix board 51 and the opposite board 52).

The backlight unit 49 shines light onto the non-light-emitting liquid crystal display panel 59. In other words, the liquid crystal display panel 59 receives the light (backlight) from the backlight unit 49, thereby performing a display function. Because of this, if the light from the backlight unit 49 is able to be evenly shined onto the entire surface of the liquid crystal display panel 59, the display quality of the liquid crystal display panel 59 improves.

And, the backlight unit 49, as shown in FIG. 17, includes: an LED module MJ; a light guide plate 21; a reflection sheet 41; a diffusion sheet 42; optical sheets 43, 44; and a built-in chassis 45.

The LED module MJ is a module that emits light and includes: a mount board 31; and an LED (Light Emitting Diode) 11 that is mounted on a not-shown electrode formed on a mount surface 31F (here, a rear surface of the mount surface 31F is called a non-mount surface 31R) of the mount board 31 and receives supply of an electric current to emit light (here, details are described later).

The light guide plate 21 is a plate-shape member that has: a side surface 21S; a top surface 21U and a bottom surface 21B which are so situated as to sandwich the side surface 21S. And, a portion of the side surface 21S faces a light-emitting surface 11L of the LED 11, thereby receiving the light from the LED 11. The received light undergoes multiple reflection in the inside of the light guide plate 21 and goes out as area light from the top surface 21U to outside (here, details are described later).

The reflection sheet 41 is so situated as to be covered by the light guide plate 21. And, one surface of the reflection sheet 41 that faces the bottom surface 21B of the light guide plate 21 serves as a reflection surface. Because of this, this reflection surface reflects the light from the LED 11 and the light traveling in the inside of the light guide plate 21 back into the light guide plate 21 without leaking both light (in detail, via the bottom surface 21B of the light guide plate 21).

The diffusion sheet 42 is so situated as to cover the top surface 21U of the light guide plate 21 and diffuses the area light from the light guide plate 21, thereby making the light reach the entire region of the liquid crystal display panel 59 (here, this diffusion sheet 42 and the optical sheets 43, 44 are also collectively called an optical sheet group).

The optical sheets 43, 44 have, for example, a prism shape in a sheet surface;

deflects a radiation characteristic of the light; and is so situated as to cover the diffusion sheet 42. Because of this, the optical sheets 43, 44 collect the light traveling from the diffusion sheet 42 to improve the brightness. Here, the respective diffusion directions of the light collected by the optical sheet 43 and the optical sheet 44 are in a relationship to intersect each other.

The built-in chassis 45 is a frame-shape base (frame edge) that holds the above various members. In detail, the built-in chassis 45 stacks up and holds the reflection sheet 41; the light guide plate 21; the diffusion sheet 42; the optical sheets 43, 44 in this order (here, the stack-up direction is called a stack-up direction P, while a direction along a long-edge direction of the built-in chassis 45 that intersects the stack-up direction P is called a long-edge direction Q and a direction along a short-edge direction of the built-in chassis 45 is called a short-edge direction R).

And, in the above backlight unit 49, the light from the LED 11 is turned into the area light by the light guide plate 21 and goes out; the area light passes through the optical sheet group, thereby going out as the backlight whose brightness is improved. And, the backlight reaches the liquid crystal display panel 59, so that the liquid crystal display panel 59 displays an image by means of the backlight.

Here, the light guide plate 21 and the LED module MJ are described in detail by means of FIG. 1 to FIG. 5. FIG. 1 is a plan view showing the light guide plate 21 and the LED module MJ that are housed in the rear bezel BZ2; and FIG. 2 is an enlarged plan view of one corner 21C of the light guide plate 21 and one LED 11.

As shown in FIG. 1, the light guide plat 21 is a plate that has the top surface 21U and the bottom surface 21B which have a hexagon obtained by cutting out both corners (that is, corners 21C1, 21C2 adjacent to each other) that are part of four corners (21C1 to 21C4) of a rectangular shape and present in one long-edge direction of two long-edge directions of the rectangular shape. And, six side surfaces 21S (21S1 to 21S6) occur on the side surface sandwiched by the top surface 21U and the bottom surface 21B because of the hexagonal top surface 21U and bottom surface 21B.

The light emitting surface 11L of the LED 11 faces the two side surfaces 21S1, 21S2 that are part of the six side surfaces 21S (21S1 to 21S6) and occur from cutting out the rectangular shape (quadrangular shape: base shape). Here, the two side surfaces 21S1, 21S2 that are part of all the side surfaces 21S1 to 21S6 are surfaces which receive light from the LED 11, so that the two side surfaces 21S1, 21S2 are also called the light receiving surfaces RS (RS1, RS2 =21S1, 21S2).

On the other hand, the LED (first light emitting device) 11 that faces the light receiving surface RS is mounted on the mount board 31. This mount board 31 is, for example, an FPC (Flexible Printed Circuits) board that has flexibility and extends linearly. Here, the length of this mount board 31 is slightly longer than the length in the long-edge direction of the light guide plate 21; and each of the LEDs 11 is mounted on each of both ends of the mount board 31.

And, this mount board 31 is so disposed as to face the long-edge side surface 21S3 of the light guide plate 21. In detail, an intermediate portion of the linear mount board 31 faces the long-edge side surface 21S3 of the light guide plate 21, while one of both ends of the mount board 31 bends toward the light receiving surface RS1 and the other of both ends of the mount board 31 bends toward the light receiving surface RS2, so that the LEDs 11, 11 face the light receiving surfaces RS (RS1, RS2).

Here, behavior of the light in the case where the light receiving surface RS and the light emitting surface 11L of the LED 11 face each other is described by means of plan views of FIG. 3 and of FIG. 4A to FIG. 4C. Here, in these figures, of lines of light flux from the LED 11, light (called a principal ray) near the center is represented by a one-dot-one-bar line arrow, while light (peripheral ray) near an edge is represented by a dotted line arrow (in short, the LED 11 diffuses and emits the light to form a line of light flux that has a predetermined directivity).

As shown in FIG. 3, when the light emitting surface 11L of the LED 11 and the light receiving surface RS face each other (both surfaces 11L, RS face each other in parallel, for example), it is possible to say about light that has a directivity to enter the light guide plate 21 via the light receiving surface RS as follows: for example, in a case where the light from one LED 11 enters from one side surface 21S (e.g., from the side surface 21S3) of the light guide plate 21, the light is unlikely to reach other surfaces 21S (e.g., the side surface 21S4, the side surface 21S6); however, when the light receiving surface RS is situated at the corner 21C of the light guide plate 21 and the LED 11 emits light that has the directivity, the light easily reaches the side surfaces 21S adjacent to the light receiving surface RS.

However, for example, when the principal ray perpendicularly enters the light receiving surface RS (at an incident angle of 90°), the principal ray perpendicularly (at an output angle of 90°) travels with respect to the light receiving surface RS; in the case where the principal ray perpendicularly enters the light receiving surface RS as described above, the peripheral ray enters the light receiving surface RS at an incident angle θ1in. Accordingly, with respect to the light receiving surface, the peripheral ray, because of Snell's Law, travels at an output angle θ1out smaller than the incident angle θ1in (the incident angle θ1in>the output angle θ1out).

And, in the inside of the light guide plate 21, in a case where the output angle θ1out is smaller than an angle δ1 of the side surface 21S adjacent to the light receiving surface RS with respect to the normal of the light receiving surface RS (the output angle θ1out<the angle δ1), the peripheral ray traveling in the inside of the light guide plate 21, as shown in FIG. 4A (which shows only the light from one of the two LEDs 11), advances to go away from the side surface 21S adjacent to the light receiving surface RS. Accordingly, if there is only one LED 11, the light becomes a little unlikely to reach near the side surface 21S adjacent to the light receiving surface RS (here, dark regions that are regions which the light is unlikely to reach are represented by slanted lines).

Besides, as shown in FIG. 4A that shows only the light from the other of the two LEDs 11), also by means of the other LED 11, the same phenomenon as in FIG. 4A occurs. In other words, if there is only one LED 11, the light becomes unlikely to reach near the side surface 21S adjacent to the light receiving surface RS.

Here, actually, the light receiving surfaces RS (RS1, RS2 =21S1, 21S2) that are formed on part of the side surface 21 S of the light guide plate 21 and face the light emitting surfaces 11L of the LEDs 11 are situated at the corners 21C of the light guide plate 21, and the positions of the corners 21C are the positions of the two corners 21C (21C1, 21C2) that are adjacent to each other on the light guide plate 21. Because of this, when these two LEDs 11 are turned on, the light from one LED 11 reaches part of the region where the light from the other LED 11 does not reach (of course, the light from the other LED 11 reaches part of the region where the light from the one LED 11 does not reach).

In detail, as shown in FIG. 4C, the light from the one LED 11 reaches most part near the short edge of the light guide plate 21 where the light from the other LED 11 does not reach, while the light from the other LED 11 reaches most part near the short edge of the light guide plate 21 where the light from the one LED 11 does not reach. Besides, the light from the one LED 11 reaches part near the long edge of the light guide plate 21 where the light from the other LED 11 does not reach, while the light from the other LED 11 reaches part near the long edge of the light guide plate 21 where the light from the one LED 11 does not reach.

In other words, the light from the LED 11 that enters from the corner 21 C of the light guide plate 21 via the light receiving surface RS relatively easily reaches the side surface 21S of the light guide plate 21 adjacent to the light receiving surface RS. In addition, even if a dark region, where it is hard for the light from only one LED 11 of the plurality of LEDs 11 does not reach, occurs near the side surface 21S adjacent to the light receiving surface RS, the light from other LEDs 11 reach the dark region.

As a result of this, in the inside of the light guide plate 21, the dark region is only part that is near the long edge of the light guide plate 21 and faces the mount board 31. In other words, even if only a relatively small number of LEDs 11 are incorporated in the backlight unit 49, in this backlight unit 49, light unevenness due to the dark region reduces.

Here, in the above description, the light receiving surfaces RS that face the light emitting surfaces 11L of the LEDs 11 are situated at the corners 21C of the light guide plate 21 and the positions of the corners 21C are the positions of the two corners 21C (21C1, 21C2) that are adjacent to each other on the light guide plate 21, which, however, is not limiting. For example, as shown in FIG. 5, the light receiving surface RS (RS3) may be formed at a corner 21C3 adjacent to the two corners 21C1, 21C2 that are adjacent to each other on the light guide plate 21; and an additional LED 11 may be incorporated corresponding to the light receiving surface RS3 (in short, on the light guide plate 21, the light receiving surfaces RS are may be formed in a line and the LEDs 11 may be disposed corresponding the respective light receiving surfaces RS).

According to this, the additionally incorporated LED 11 shines light onto the dark region that occurs near the long edge from the corner 21C1 to the corner 21C2 of the light guide plate 21. Because of this, in such backlight unit 49, the light unevenness due to the dark region reduces more surely. Of course, to further reduce the dark region, the light receiving surface RS may be formed at all the corners 21C (21C1 to 21C4) of the light guide plate 21 and the LEDs 11 may be incorporated corresponding to these light receiving surfaces RS.

Here, when the light receiving surfaces RS that face the light emitting surfaces 11L of the LEDs 11 are situated at the positions of the corners 21C of the light guide plate 21 and the positions of the corners 21C are the positions of at least two corners 21C that are adjacent to each other on the light guide plate 21, it is possible to curb occurrence of the dark region as small as possible.

In the meantime, the inclination angle of the light receiving surface RS is an angle defined by one side surface 21S of the light guide plate 21 adjacent to the light receiving surface RS and the light receiving surface RS (here, an angle defined by one long-edge side surface 21 S of the light guide plate 21 and the light receiving surface RS). And, it is desirable that this inclination angle of the light receiving surface RS variously changes in accordance with the directivity (directional angle) of the light from the LED 11.

For example, in a case where the directional angle of the LED 11 is 84° (in other words, the angle defined by the principal ray and the peripheral ray is 42°, it is desirable that the inclination angle of the light receiving surface RS is about 135° (e.g., (δ+90)° in FIG. 3 is about 135°) According to this, it becomes easy for the light from the LED 11 to reach the long-edge side surfaces 21S3, 21S5 of the light guide plate 21. In addition, if the angle defined by the long-edge side surface 21S of the quadrangular light guide plate 21 and the short-edge side surface 21 S of the quadrangular light guide plate 21 is a bout 90°, the angle defined by the short-edge side surface 21 S4 of the light guide plate 21 and the light receiving surface RS also becomes about 135°. Because of this, it becomes easy for the light from the LED 11 to reach the short-edge side surfaces 21S4, 21S6 as well of the light guide plate 21.

Here, on the bottom of the rear bezel BZ2, as shown in FIG. 17, a hold portion HD, which holds a portion of the mount board 31 on which the LED 11 is mounted, may be formed. In detail, this hold portion HD rises from the bottom surface of the rear bezel BZ2, while pushes a portion of the mount board 31, for example, a portion of the non-mount surface 31R which overlaps with the LED 11, threby holding the portion of the mount board 31(in short, the hold portion HD indirectly holds the LED 11 via the mount board 31).

And, because there is such hold portion HD, it is possible to easily make the mount board 31 unmoved with respect to the rear bezel BZ2 (e.g., it becomes possible to fix the hold portion HD and the mount board 31 to each other by means of an adhesive). Further, in a case the hold portion HD is so formed as to face the light receiving surface RS of the light guide plate 21; and the light receiving surface RS and one surface of the hold portion HD are parallel with each other, if the portion of the non-mount surface 31R that overlaps with the LED 11 comes into tight contact with the one surface of the hold portion HD, the light receiving surface RS and the light emitting surface 11L of the LED 11 easily become parallel with each other. According to this, the principal ray from the LED 11 efficiently enters the light receiving surface RS.

### Embodiment 2

An embodiment 2 is described. Here, members that have the same functions as members used in the embodiment 1 are indicated by the same reference numbers and description of them is skipped.

In the embodiment 1, the one-plane light receiving surface RS is described as an example. However, this is not limiting. For example, as shown in a plan view of FIG. 6, on one light receiving surface RS, one concave DH that caves in the traveling direction of the light from the LED 11 may be formed. For example, by connecting a plurality of small surfaces SS (SS1 to SS3) to each other in such a way that an angle (included angle α) under 180° occurs between the small surfaces SS, the concave DH that caves in the traveling direction of the light from the LED 11 may be formed on the light receiving surface RS.

According to this, an inner surface (and the light receiving surface RS) of the concave DH becomes a polygonal surface that is formed by arranging the plurality of small surfaces SS. And, according to the polygonal-shape light receiving surface RS, the light from the LED 11 easily spreads (here, the process for forming the non-planar concave DH which changes the traveling direction of the light received by the light receiving surface RS is called a non-plane forming process). For example, as shown in FIG. 6, it is supposed that the light receiving surface RS is formed by the small surface SS1 parallel with the light emitting surface 11L of the LED 11 and by the small surfaces SS2, SS3 that serve as inner walls (wall portions of the inner surface of the concave DH) of the concave DH whose bottom is the small surface SS1.

According to this, if the principal ray (see a one-dot-one-bar line arrow) from the LED 11 perpendicularly enters the light guide plate 21 via the small surface SS1, the principal ray travels following Snell's Law. In other words, the principal ray travels perpendicularly to the light receiving surface RS. On the other hand, the peripheral rays (see dotted line arrows) enter the small surfaces SS2, SS3 at incident angles θ2in, and because of Snell's Law, travel, with respect to the light receiving surface RS, at output angles θ2out that are smaller than the incident angle θ2in (the incident angle θ2in >the output angle θ2out).

Here, the small surfaces SS2, SS3 have the predetermined included angle α to the small surface SS1. In detail, between the surfaces (between the small surface SS1 and the small surface SS2 and between the small surface SS1 and the small surface SS3) for receiving the light, the included angle α occurs. Because of this, the incident angle θ2in is smaller than the incident angle (the incident angle θ1in; see FIG. 3) in the case where the peripheral ray enters the small surface SS1.

Accordingly, the output angle θ2out also becomes relatively small (e.g, the output angle θ2out<the output angle θ1out; see FIG. 3). Here, if it is supposed that in the inside of the light guide plate 21, angles of the side surfaces 21S adjacent to the small surfaces SS2, SS3 with respect to the normals of the small surfaces SS2, SS3 are angles δ2, angles (672 +90°) defined by the side surfaces 21S adjacent to the small surfaces SS2, SS3 and the small surfaces SS2, SS3 also become relatively small (e.g, (δ2+90°) is smaller than an angle (δ1+90°) defined by the one-plane light receiving surface RS and the side surface 21S shown in FIG. 3).

Because of this, the light that travels in the inside of the light guide plate 21 at the output angles θ2out to the small surfaces SS2, SS3 travels without excessively going away from the side surfaces 21S adjacent to the small surfaces SS2, SS3. In other words, in the light guide plate 21, the go-away degree of the peripheral ray with respect to the side surface 21S adjacent to the light receiving surface RS (in detail, the small surfaces SS2, SS3) is curbed. For example, the go-away degree of the peripheral ray in FIG. 6 from the side surface 21S adjacent to the light receiving surface RS is smaller than the go-away degree of the peripheral ray in FIG. 3 from the side surface 21S adjacent to the light receiving surface RS.

As described above, in the light guide plate 21, the light that enters the concave light receiving surface RS travels spreading widely in the inside of the light guide plate 21 compared with the light that enters the one-surface light receiving surface RS. Accordingly, the area of the dark region that occurs on the side surface 21S adjacent to the light receiving surface RS reduces and the light unevenness due to the dark region decreases.

Here, the number of the small surfaces SS that form the light receiving surface

RS of the light guide plate 21 is not limited to three shown in FIG. 6. For example, as shown in FIG. 7, there may be two small surfaces SS (SS4, SS5) or may be four or mor small surfaces SS (in short, it is sufficient if the light receiving surface RS is formed into a polygonal surface, which includes a plurality of arranged small surfaces SS, in such a way that the light receiving surface RS caves in the traveling direction of the light from the LED 11). Further, as shown in FIG. 8, a curved surface may be employed, in which the number of the small surfaces SS increases and the light receiving surface RS may be a curved surface that caves in the traveling direction of the light from the LED 11 (in short, the inner surface of the concave DH may be a curves surface).

This is because if the light receiving surface RS caves in the traveling direction of the light from the LED 11, the light traveling from the light receiving surface RS travels without excessively going away from the side surface 21S adjacent to the light receiving surface RS (especially, if the light receiving surface RS is a curved surface, a minimum surface including the incident points of the rays (the principal ray, the peripheral ray) in the light receiving surface RS becomes perpendicular to the rays, so that the rays become unlikely to go away from the side surface 21S adjacent to the light receiving surface RS).

In the meantime, in the above description, one LED 11 corresponds to one light receiving surface RS that is formed at one corner 21C of the light guide plate 21. However, this is not limiting. For example, as shown in FIG. 9, in the same direction as the arrangement direction of the small surfaces SS, a plurality of LEDs 11 may be arranged in parallel with each other on one planar surface of the mount board 31 (here, instead of the polygonal-plane light receiving surface RS, the plurality of LEDs 11 may be arranged in parallel with the one-plane light receiving surface RS).

According to this, it is possible to make the LED 11 having relatively high brightness correspond to one light receiving surface RS, or it is possible to make a plurality of LEDs 11 that do not have high brightness but are inexpensive correspond to one light receiving surface RS. In other words, if there is no problem even if the number of the LEDs 11 is single or more, choices of the LED 11 that are able to be incorporated in the backlight unit 49 increase.

Here, in the case where the light receiving surface RS of the light guide plate 21 is a polygonal surface, as shown in FIG. 10, it is desirable that each LED 11 is disposed to face each of the plurality of small surfaces SS included in the light receiving surface RS. In detail, it is desirable that the small surfaces SS and the LEDs 11 corresponding to the respective small surfaces SS1 to SS3 are disposed in parallel to face each other.

According to this, the principal rays (see one-dot-one-bar line arrows) from the

LEDs 11 travel along the normal directions of the small surfaces SS1 to SS3, and light that has relatively high light intensity reaches near the side surfaces 21S as well adjacent to the light receiving surfaces RS (in detail, the small surfaces SS2, SS3). In addition, the peripheral rays (see dotted line arrows) from the LEDs 11 reach the side surfaces 21S nearer than the principal rays. Because of this, the area of the dark regions that occur on the side surfaces 21S adjacent to the light receiving surface RS surely reduces and the light unevenness due to the dark regions also reduces.

Here, in the above description, the three LEDs 11 are arranged on a plane (a QR plane direction defined by a Q direction and an R direction) that is defined by the long-edge direction and short-edge direction of the light guide plate 21. However, this is not limiting. For example, the plurality of LEDs 11 may be arranged along a thickness direction (P direction) of the light guide plate 21. In short, it is sufficient if it is possible to supply the light to the light receiving surfaces RS.

Besides, in the case where the light receiving surface RS is the polygonal surface, it is desirable that the included angle α between the small surfaces SS also change in accordance with the directivity (directional angle) of the light from the LED 11 (here, the included angle α is an angle defined by the small surfaces SS on an outer portion of the light guide plate 21). For example, in the case where the directional angle of the LED 11 is 84°, on the light receiving surface RS that includes the small surfaces SS1 to SS3, if the small surface SS1 has an inclination angle of about 135° to the long-edge and short-edge side surfaces 21 S of the light guide plate 21, it is sufficient if the included angles α of the small surfaces SS2, SS3 to the small surface SS1 are about 175°.

Besides, for example, in the case where the directional angle of the LED 11 is 84°, on the light receiving surface RS that includes the small surfaces SS4, SS5 as shown in FIG. 7, it is sufficient if the included angle α from the small surface SS4 to the small surface SS5 is from about 160° to about 174°.

According to these structures, the light traveling from the small surface SS adjacent to the side surface 21S of the light guide plate 21 easily reaches the side surface 21S. Because of this, the dark region is further unlikely to occur in the light guide plate 21.

Besides, in the above description, on one light receiving surface RS, one concave DH that caves in the traveling direction of the light from the LED 11 is formed, which, however, is not limiting. For example, as shown in FIG. 11, on one light receiving surface RS, a convex BG that swells toward the LED 11 may be formed.

For example, by connecting the plurality of small surfaces SS1 to SS3 to each other in such a way that an angle (included angle β) over 180° occurs between the small surfaces SS (between the small surface SS1 and the small surface SS2, and between the small surface SS1 and the small surface SS3), and further an angle (included angle γ) over 180° occurs between part (SS2, SS3) of the small surfaces and the side surface 21S, the convex BG that swells toward the start point of the light from the LED 11 may be formed on the light receiving surface RS.

According to this, the surface of the convex BG (and the light receiving surface RS) becomes a polygonal surface that includes the plurality of arranged small surfaces SS. And, according to the polygonal light receiving surface RS, like in the case of the light receiving surface RS that is polygonal and has the concave DH, the light from the LED 11 easily spreads. For example, part of the light from the LED 11 near the long-edge side surface 21S3 of the light guide plate 21 travels toward the short-edge side surface 21S4 of the light guide plate 21 via the small surface SS3. On the other hand, part of the light from the LED 11 near the short-edge side surface 21S4 of the light guide plate 21 travels toward the long-edge side surface 21S3 of the light guide plate 21 via the small surface SS2.

Accordingly, the light that enters the light receiving surface RS including the convex BG travels spreading widely in the inside of the light guide plate 21 compared with the light that enters the one-plane light receiving surface RS. As a result of this, the area of the dark region that occurs on the side surface 21S adjacent to the light receiving surface RS reduces and the light unevenness due to the dark region decreases.

Here, in FIG. 11, the light emitting surface 11L of each LED 11 is disposed to face each of the small surfaces SS (SS1 to SS3) of the light receiving surface RS, which, however, is not limiting. For example, in the same direction as the arrangement direction of the small surfaces SS, the plurality of LEDs 11 may be arranged in parallel with each other on one surface of the mount board 31 (see FIG. 9).

Besides, the light receiving surface RS including the convex BG may not be the polygonal surface that includes the three small surfaces SS1 to SS3 but may be a polygonal surface that includes two small surfaces SS or four or more small surfaces SS (in short, it is sufficient if the light receiving surface RS is formed into a polygonal surface, which includes a plurality of arranged small surfaces SS, in such a way that the light receiving surface RS swells toward the LED 11). Further, the number of the small surfaces SS may increase and the light receiving surface RS may be a curved surface that swells toward the LED 11 (in short, the surface of the convex BG may be a curves surface).

### Other Embodiments

Here, the present invention is not limited to the above embodiments; and various modifications are possible without departing from the spirit of the present invention.

For example, as shown in FIG. 12A, not only the LED 11 is disposed to face the light receiving surface RS of the corner 21C of the light guide plate 21 but also an additional LED (second light emitting device) 12 may be disposed with a light emitting surface 12L facing the long-edge side surface 21S of the light guide plate 21 adjacent to the light receiving surface RS.

Of course, as shown in FIG. 12B, the LED 12 may be disposed in such a way that the light emitting surface 12L faces the short-edge side surface 21S of the light guide plate 21 adjacent to the light receiving surface RS. According to this, between the short-edge side surface 21S on the incident side and the other short-edge side surface 21S, the light from the LED 12 spreads into a relatively wide area. In other words, the light reaches into the wide area in the light guide plate 21. Because of this, the use efficiency of the light from the LED 12 is high.

Besides, as shown in FIG. 12C, the LEDs 12, 12 may be disposed in such a way that the light emitting surfaces 12L face the long-edge side surface 21S and short-edge side surface 21S of the light guide plate 21 adjacent to the light receiving surface RS. In short, it is sufficient if on at least one of the side surfaces 21S that are adjacent to each other with respect to the light receiving surface RS, the light emitting surface 12L of the LED 12 faces a place that is adjacent to the light receiving surface RS.

And, if on the side surface 21S of the light guide plate 21, the LED 12 is disposed at the place that is adjacent to the light receiving surface RS, the light from the LED 12 enters from the side surface 21S where the dark region easily occurs. Because of this, the dark region near the side surface 21S disappears to turn into a bright region.

Here, the LED 12 has the purpose of improving the brightness near the side surface 21S of the light guide plate 21, so that an LED having low brightness compared with the LED 11 may be used. Besides, because of the same reason, the number of LEDs 12 that face one side surface 21S may also be smaller than the number of LEDs 11 that face the light receiving surface RS.

In the meantime, in the above description, the mount board 31 is a board that has a chief purpose of supplying an electric current to the LED 11, which, however, is not limiting. For example, as shown in an explosive perspective view of the liquid crystal display device 69 in FIG. 13 and in FIG. 14 that is a plan view showing both of a partial side view and a partial plan view of the liquid crystal display device 69, on a control board 32 necessary for operation control of the liquid crystal display panel 59, the LED 11 may be mounted (here, in FIG. 14, for convenience, both bezels BZ1, BZ2, the built-in chassis 45 and the like are omitted; especially, in the plan view, only the light guide plate 21, the control board 32 and the LED 11 are shown).

For example, on the high-hardness control board 32 (control board) on which a gate driver, a source drive and the like for controlling the switching devices such as the TFTs and the like in the liquid crystal display panel 59 are mounted, the LED 11 may be mounted. In detail, the LED 11 may be mounted on the control board 32 that connects with the liquid crystal display panel 59 via the FPC board 33 that has flexibility.

According to this, as shown in FIG. 13, even if a board surface of the control board 32 on which the LED 11 is mounted faces toward the top surface 21U of the light guide plate 21, the board surface rotates (overturns) as indicated by an arrow X, and as shown in FIG. 14, faces toward the bottom surface 21B of the light guide plate 21. According to this, the light emitting surface 11L of the LED 11 that rises from the board surface of the control board 32 comes close to the light receiving surface RS of the light guide plate 21 and it is possible to incorporate the LED 11 in the backlight unit 49 easily and inexpensively.

Here, the flexibility of the control board 32 does not matter. For example, as shown in FIG. 13 and FIG. 14, the high-hardness control board 32 may be used, or the control board 32 (e.g., film-like control board 32) that has flexibility like the FPC board 33 may be used. Here, in a case of the film-like control board 32, it is desirable that there is the hold portion HD as shown in FIG. 17 (in this case, the hold portion HD comes into contact with the LED 11 on the control board 32 to directly hold the LED 11).

Besides, the hold portion HD is formed on the rear bezel BZ2, which, however, is not limiting. For example, in a case where a metal board cover for protecting the control board 32 is incorporated, the hold portion HD may be formed on the board cover.

For example, in a case where the control board 32 is connected to the liquid crystal display panel 59 via the FPC board 33 that has flexibility; and the LED module MJ is incorporated in the liquid crystal display device 69, as shown in a plan view of FIG. 15A that shows these components, if the control board 32 rotates as indicated by the arrow X, as shown in a plan view of FIG. 15B, the control board 32 faces toward the bottom surface 21B of the light guide plate 21. And, as shown in FIG. 15B, a board cover CV covers such control board 32.

The board cover CV, as shown in FIG. 16 (two-directional view that shows both of a partial side view and a partial plan view of the liquid crystal display device 69), rises from a bottom surface 35 of itself; includes a wall surface 36 that encloses the control board 32; and includes the hold portion HD as well (see dot shading). And, this board cover CV protects the control board 32, while being present between the front bezel BZ1 and the rear bezel BZ2. And, the hold portion HD pushes a portion of the mount board 31, for example, a portion of the non-mount surface 31R which overlaps with the LED 11, thereby holding the portion of the mount board 31.

By connecting the board cover CV to at least one of the front bezel BZ1 and the rear bezel BZ2, such hold portion HD is able to easily make the mount board 31 (and LED 11) unmoved with respect to at least one bezel BZ. Further, like in the embodiment 1, in the case where the hold portion HD is so formed as to face the light receiving surface RS of the light guide plate 21; and the light receiving surface RS and one surface of the hold portion HD are parallel with each other, if the portion of the non-mount surface 31R that overlaps with the LED 11 comes into tight contact with the one surface of the hold portion HD, the light receiving surface RS and the light emitting surface 11L of the LED 11 easily become parallel with each other. According to this, the principal ray from the LED 11 efficiently enters the light receiving surface RS.

In addition, the board cover CV, which has electrical conductivity and heat radiation and is made of a metal or the like, performs not only a function as a measure against EMI (Electromagnetic Interference) but also a function as a path (heat radiation path) for radiating heat stored in the LED 11 because the board cover CV connects with the LED 11 via the mount board 31. Because of this, an additional heat radiation plate for the LED 11 becomes unnecessary (in other words, it is possible to achieve cost reduction of the liquid crystal display device 69).

Here, in the above description, the hold portion HD of the board cover CV and the hold portion HD of the rear bezel BZ2 hold the LED 11 directly or indirectly, which, however, is not limiting. For example, the hold portion HD, as in the case of holding the LED 11, may hold the LED 12 directly or indirectly (in short, it is sufficient if the hold potion HD of the board cover CV and the hold portion HD of the rear bezel BZ2 are able to hold directly or indirectly at least one of the LED 11 and the LED 12).

In the meantime, in the above description, the shape (base shape) of the light guide plate 21 in the case where it is supposed that the light receiving surface RS is not formed is the quadrangle. However, the shape is not limited to this. For example, the light guide plate 21, which has a polygonal shape (a plate shape having three corners 21C or a plate shape having five or more corners 21C) as the base shape that is more polygonal than triangular, pentagonal or more, may be used.

Here, even in a case where the light guide plate 21 has various polygonal shapes, it is desirable that the light receiving surfaces RS, which are formed on a portion of the side surface 21 S of the light guide plate 21 and face the light emitting surface 11L of the LED 11, are situated at corners 21C of the light guide plate 21 and the positions of the corners 21C are the positions of at least two corners 21C that are adjacent to each other on the light guide plate 21. According to this, in the light guide plate 21, another LED 11 is able to make the light reach a region where one LED 11 is not able to make the light reach. Because of this, occurrence of the dark region in the light guide plate 21 reduces.

Of course, the light receiving surface RS may be formed at two or more corners 21C of the polygonal light guide plate 21. In contrast, as described in the embodiment 2, if one light receiving surface RS includes one concave DH that caves in the traveling direction of the light from the LED 11; and the inner surface of the concave DH is able to sufficiently diffuse the light while make the light travel into the inside of the light guide plate 21, only one concave light receiving surface RS may be formed at one corner 21C of the light guide plate 21.

### REFERENCE SIGNS LIST

MJ LED module

11 LED (first light emitting device)

11L light emitting surface

12 LED (second light emitting device)

12L light emitting surface

21 light guide plate

21U top surface of light guide plate

21B bottom surface of light guide plate

21S side surface of light guide plate

21C corner of light guide plate

RS light receiving surface of light guide plate

SS small surface (light receiving surface) for forming light guide plate

DH concave (light receiving surface)

BG convex (light receiving surface)

31 mount board

31F mount surface

31R non-mount surface

32 control board (mount board, control board)

33 FPC board

CV board cover

35 bottom surface of board cover

36 wall surface of board cover

41 reflection sheet

42 diffusion sheet

43 optical sheet

44 optical sheet

45 built-in chassis

49 backlight unit

59 liquid crystal display panel

BZ1 front bezel (frame)

BZ2 rear bezel (frame)

HD hold portion

69 liquid crystal display device

1. A backlight unit comprising:
a first light emitting device; and
a light guide plate that receives light from the first light emitting device and transmits the light to guide the light from a top surface to outside;
wherein light receiving surfaces, which are formed on part of a side surface of the light guide plate and face a light emitting surface of the first light emitting device, are situated at corners of the light guide plate; and positions of the corners are positions of at least two corners that are adjacent to each other on the light guide plate.

2. The backlight unit according to claim 1, wherein one or a plurality of the first light emitting devices are disposed corresponding to one of the light receiving surfaces.

3. The backlight unit according to claim 2, wherein on one of the light receiving surface, a non-planar shape that changes a travel direction of received light is formed.

4. The backlight unit according to claim 3, wherein on one of the light receiving surfaces, one concave that caves in a travel direction of the light from the first light emitting device is formed.

5. The backlight unit according to claim 4, wherein an inner surface of the concave is a polygonal surface that includes a plurality of arranged small surfaces.

6. The backlight unit according to claim 4, wherein the inner surface of the concave is a curved surface.

7. The backlight unit according to claim 3, wherein on the one of the light receiving surfaces, a convex that swells toward the light emitting surface of the first light emitting device is formed.

8. The backlight unit according to claim 7, wherein a surface of the convex is a polygonal surface that includes a plurality of arranged small surfaces.

9. The backlight unit according to claim 8, wherein the surface of the convex is a curved surface.

10. The backlight unit according to claim 5, wherein one light emitting surface of the first light emitting device is disposed to face each of the plurality of small surfaces.

11. The backlight unit according to claim 1, wherein near at least one of the side surfaces that are adjacent to each other with respect to the light receiving surface, a light emitting surface of a second light emitting device faces a place that is adjacent to the light receiving surface.

12. The backlight unit according to claim 1, wherein
the light emitting devices are mounted on a mount board;
the mount board on which the light emitting devices are mounted and the light guide plate are housed in a frame; and
on the frame, a hold portion that holds directly or indirectly the light emitting device is formed.

13. A liquid crystal display device comprising:
the backlight unit according to claim 1; and
a liquid crystal display panel that receives the light from the backlight unit.

14. A liquid crystal display device comprising:
the backlight unit according to claim 12; and
a liquid crystal display panel that receives the light from the backlight unit;
wherein the mount board is also a control board that is used for control of the liquid crystal display panel.

15. A liquid crystal display device comprising:
the backlight unit according to claim 1; and
a liquid crystal display panel that receives the light from the backlight unit;
the liquid crystal display device comprises:
a mount board on which the light emitting device is mounted;
a control board that is used for control of the liquid crystal display panel; and
a board cover that has electrical conductivity and heat radiation which protects the control board;
wherein on the board cover, a hold portion that holds directly or indirectly the light emitting device is formed.

16. The backlight unit according to claim 8, wherein one light emitting surface of the first light emitting device is disposed to face each of the plurality of small surfaces.

17. A liquid crystal display device comprising:
the backlight unit according to claim 12; and
a liquid crystal display panel that receives the light from the backlight unit.
